(19) United States
(12) Patent Application Publication
(10) Pub. No.: US 2010/0076881 A1
(43) Pub. Date: Mar. 25, 2010

(54) Enhanced Valuation System and Method for Real Estate

(76) Inventors: Thomas Liam O'Grady, Medfield, MA (US); Christopher Brian Carey, Burlington, MA (US)

Correspondence Address: FOX ROTHSCHILD, LLP;Pittsburgh, 997 Lenox Drive, Bldg. #3, Lawrenceville, NJ, 08648, US

(21) Appl. No.: 12/233,692

(22) Filed: Sep. 19, 2008

(51) Int. Cl. G06Q 40/00; G06Q 10/00

(52) U.S. Cl. 705/35; 705/1

(57) ABSTRACT

A system and method for producing a valuation for real property that allows the rating of various metrics that contribute to a determination of value for the subject property, the rating being based on the quality and applicability to the subject property of the data sources from which data is gathered for each metric, such that the final valuation is based on a weighted average of each of the metrics, thereby eliminating the human bias from the actual valuation result, but providing an improved result over a valuation based solely on results from an automated valuation model.

### BACKGROUND OF THE INVENTION

Automated valuation models (AVM's) for real estate are well known in the art. An AVM is typically a computer program that uses an automated process to calculate the value of a certain piece of real property. The AVM uses one or more databases of pre-compiled data regarding various parameters and characteristics of like properties, and performs a data analysis to find comparable properties to the property being evaluated.

The AVM may use statistical models and algorithms, such as linear or multiple regression analysis, or may get information from a geographic information systems (GIS). Linear regression adjusts for one variable, such as the age of a property. For each change in age, the same change in price is applied to the value of the property. Multiple regression is a similar process, though it uses a series of variables simultaneously.

Typically, the AVM produces a report with a proposed value of the property within a specific value range. The report can stand alone or may be supplemented by information from human appraisers to form a final valuation of the property.

While AVMs are accurate when used in a very homogeneous area, they may be much less accurate in other instances, such as when they are used in rural areas, or when the appraised property does not conform well to the neighborhood. Additionally, AVM's are inherently empirical and lack a means for adding a subjective element to the valuation, such as input regarding the present condition of a property, actual size, views, location, improvements, and other intangibles. In addition, typical AVM's are unable to take into account other factors, such as an assessment of risk and fraud which may be associated with a particular property or neighborhood.

In addition, the valuation produced by an AVM is only as good as the data upon which the valuation is based. Databases used by an AVM may be out of date, for instance, not containing the latest comparable sales.

At the other end of the spectrum, properties may be evaluated solely by an appraiser, typically a real estate professional, who may visit and inspect the property, select appropriate comparables and form a valuation based on personal experience. While AVMs are objective in nature, a valuation by an appraiser is inherently subjective in nature and may be biased by the appraiser's personal opinions. Even a valuation by an appraiser that uses an AVM valuation as a starting point may be subjectively tainted by the appraiser's opinions.

As a result, there exists a need for a system and method to improve the accuracy and value of a valuation produced by an AVM that is not inflexibly objective, but which eliminates the subjective nature of the human element in the valuation.

### SUMMARY OF THE INVENTION

The present invention meets these objectives by introducing a system and method of valuation that allows a person to integrate the results from AVM's with local data, local knowledge and an appraiser's experience to produce a more accurate valuation of a given property. The system and method also allows the integration of risk and fraud models with local valuation data.

The system and method utilizes valuation from AVM's as well as automated data sources that contain information regarding various attributes of the property in question and potential comparable properties, such as square footage, number of rooms, recent sales, recent foreclosures, and information about the immediate neighborhood of the subject property, such as high foreclosure rates, indicators of fraud, how quickly properties in the area sell, etc.

The system and method takes all of the available data sources into account and allows a human to rate whether or not the data sources used are good or bad indicators of value for a particular subject property. Based on this evaluation of the data sources, the data sources may be weighted in their contribution to the final valuation. As such, human subjectivity may be used improve the confidence in the data used by the AVM, while eliminating the human bias in the final valuation.

### DESCRIPTION OF THE DRAWINGS

FIG. 1 is a portion of a flow chart of the system and method of the present invention.

FIG. 2 is a continuation of the flow chart of FIG. 1.

FIG. 3 is a continuation of the flow chart of FIG. 2.

FIG. 4 is a continuation of the flow chart of FIG. 3.

FIG. 5 is a screen capture from one embodiment of the program showing a screen wherein a vendor may enter information regarding the subject property.

FIG. 6 is a screen capture from one embodiment of the program showing a screen wherein a vendor may enter information regarding the neighborhood of the subject property.

FIG. 7 is a screen capture from one embodiment of the program showing a screen wherein a vendor may enter information regarding comparable properties to the subject property.

FIG. 8 is a screen capture from one embodiment of the program showing a screen wherein a final rule check is performed before the information entered by a vendor is submitted to the reviewer's queue.

FIG. 9 is a screen capture from one embodiment of the program showing a screen wherein a reviewer may select to use data for each data point either from an integrated data source or from vendor-supplied data.

FIG. 10 is a screen capture from one embodiment of the program showing a screen wherein a reviewer may select and rate comparable properties to the subject property.

FIG. 11 is a screen capture from one embodiment of the program showing a screen wherein the result from the value engine are displayed and wherein a reviewer provide weights for various metrics to be used in the final valuation of the subject property.

### DETAILED DESCRIPTION OF THE INVENTION

It is understood that the description of the system and method of the present invention necessarily includes standard hardware and software components, including computers, memories, storage devices, operating systems and networking capabilities, that would allow or enable the described functions and activities. Such systems may be standard, off-the-shelf components without customization, such as a typical personal computer, as are well known to those of skill in the art, even if not explicitly otherwise mentioned.

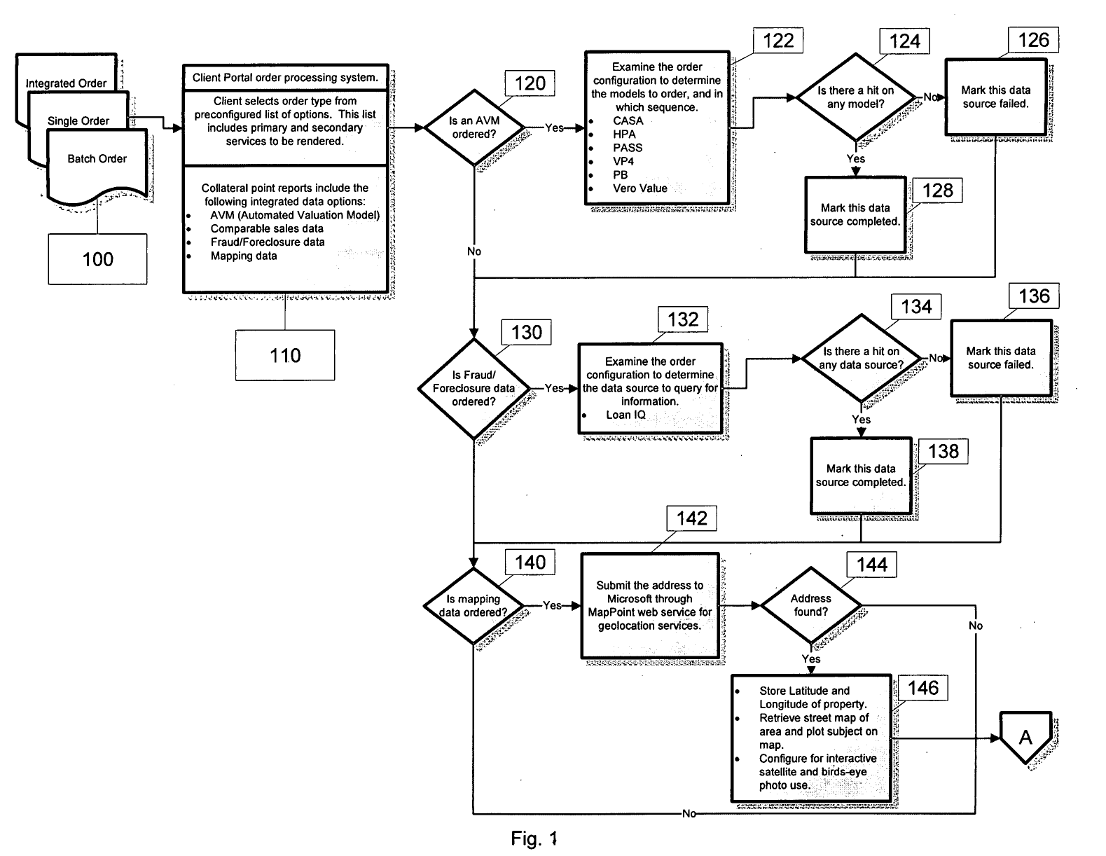

The system and method will be described with reference to FIGS. 1-4 which show a flow chart of one possible embodiment of the claimed system. As is understood by those of skill in the software arts, many different specific embodiments of a system providing the same functionality could be implemented by a skilled software engineer. As such, the particular embodiment described is provided as only one example of possible implementation of the system and is not meant to limit the scope of the invention to that particular embodiment. Instead, the scope of the system is defined by the functions and methods described herein.

With reference now to FIG. 1, at reference number 100, the user is able to submit an order for a single property, a batch order for multiple properties or an integrated order, which will automatically receive orders from clients for certain properties. In box 110 the user is asked to select a particular type of report. The types of reports produced by the system vary in the amount of detail in both the data used and in the final report.

In the preferred embodiment, the basic level of report will be a report which contains “collateral points” of information which have been obtained from integrated data sources and which may include one or more of the following types of information: an valuation obtained from an automated valuation model, comparable sales data, fraud and foreclosure data and mapping data. In more detailed reports, other different types of data, not available from an integrated data source, may also be considered.

Flow continues to box 120 where it is determined if an automated valuation model has been ordered. If so, flow proceeds to box 122 wherein various automated valuation models are consulted in a particular order to ascertain if any of the models listed contain valuation for the subject property. In box 124 it is determined if there is a hit on any of the models in the list and, if so, the data source is marked “completed” in box 128. If no hit is found then the data source is marked as “failed” in box 126.

Control then passes to box 130 where it is determined if a fraud and foreclosure data report is necessary. If not, control passes to box 140. If fraud and foreclosure data has been ordered, flow continues to box 132 where it is determined which source and the order of the sources from which to obtain the fraud and foreclosure data. Such information may be obtained from an integrated data source, such a Loan IQ™. If there is a hit for the subject property within any of the databases from which fraud and foreclosure data may be obtained, the data source is marked as completed in box 138. If no hit is obtained then the data source is marked as failed in box 136.

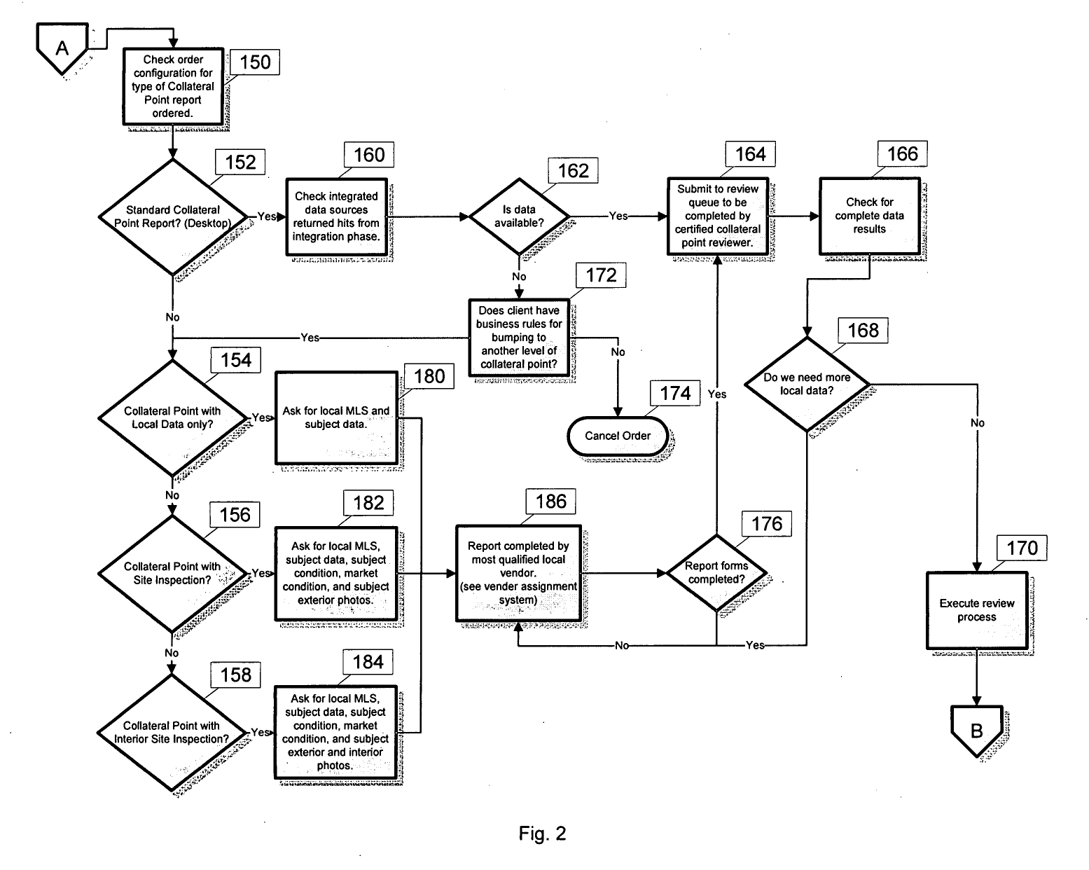

Control the passes to box 140 where it is determined if mapping data has been ordered. Mapping data would include data regarding physical maps such as may be obtained from Microsoft or Google mapping services. In addition, satellite and bird's-eye imagery may be obtained. If mapping data is required, then flow passes to box 142 where the address of the subject property is submitted to one or more mapping services. Flow then passes to box 144 where it is determined if the subject address has been found. If so, various information regarding the subject property is stored in box 146, including such information as latitude and longitude of the property. In addition, the street map of the area and subject property is obtained as well as satellite and bird's-eye photos of the site, if available. Once the data has been obtained from the data source in box 146, control passes to box “A” on FIG. 2.

Now with respect to FIG. 2, in box 150 the order is checked to determine which type of report has been ordered. In the preferred embodiment of the invention, there are basically four types of different reports, varying by the data upon which they are based and the level of detail. Other types of reports may be offered without departing from the scope of the invention.

The first report type, in box 152 is a standard “collateral point” report which includes all of the integrated data sources which were automatically searched in FIG. 1. In box 154 the basic collateral point report is augmented by local data, typically obtained from a local multiple listing service. This data may be manually entered into the system, or may be electronically transferred in an interface to the database is available. In box 156, the collateral point inspection with local data is augmented by an onsite inspection of the property by a real estate professional, and, in box 158, a collateral point report with local data and an interior site inspection may be requested.

Reports using any available mix of information may also be provided, although they are not shown in the flow chart. For example, if no local data is available, the basic collateral point report, based on data gathered from integrated data sources, may be augmented by the on-site inspection. Basically, any combination of data sources may be combined and will still be within the scope of the invention.

In box 160, the data obtained from the integrated data sources in FIG. 1 are checked to see if there were any hits for the subject property. In box 162, a decision is made as to whether the data is available or not. If the data is available, flow passes to box 164, where the request for valuation is submitted to a review queue to be completed by a real estate professional. In box 166, a check is made to determine if we have complete data (i.e., enough valid data upon which to base a report) and, in box 168, a decision is made whether more local data is needed. If no more local data is needed, flow proceeds to box 170, where the review process is performed.

If data is not available at decision point 162, flow passes to box 172 where it is determined if the particular client has business rules regarding moving to a more detailed type of report. If there are no such business rules, the operation is cancelled in box 174. However, if such business rules exist, then a more detailed report will be ordered.

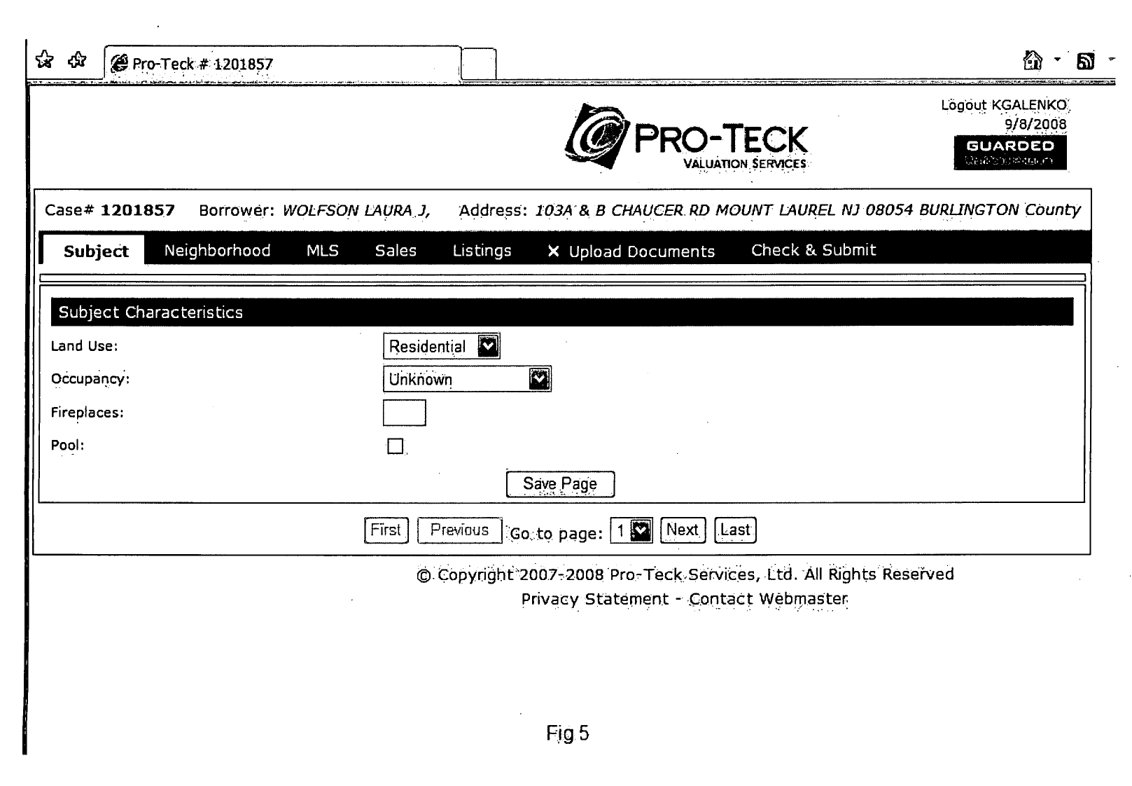

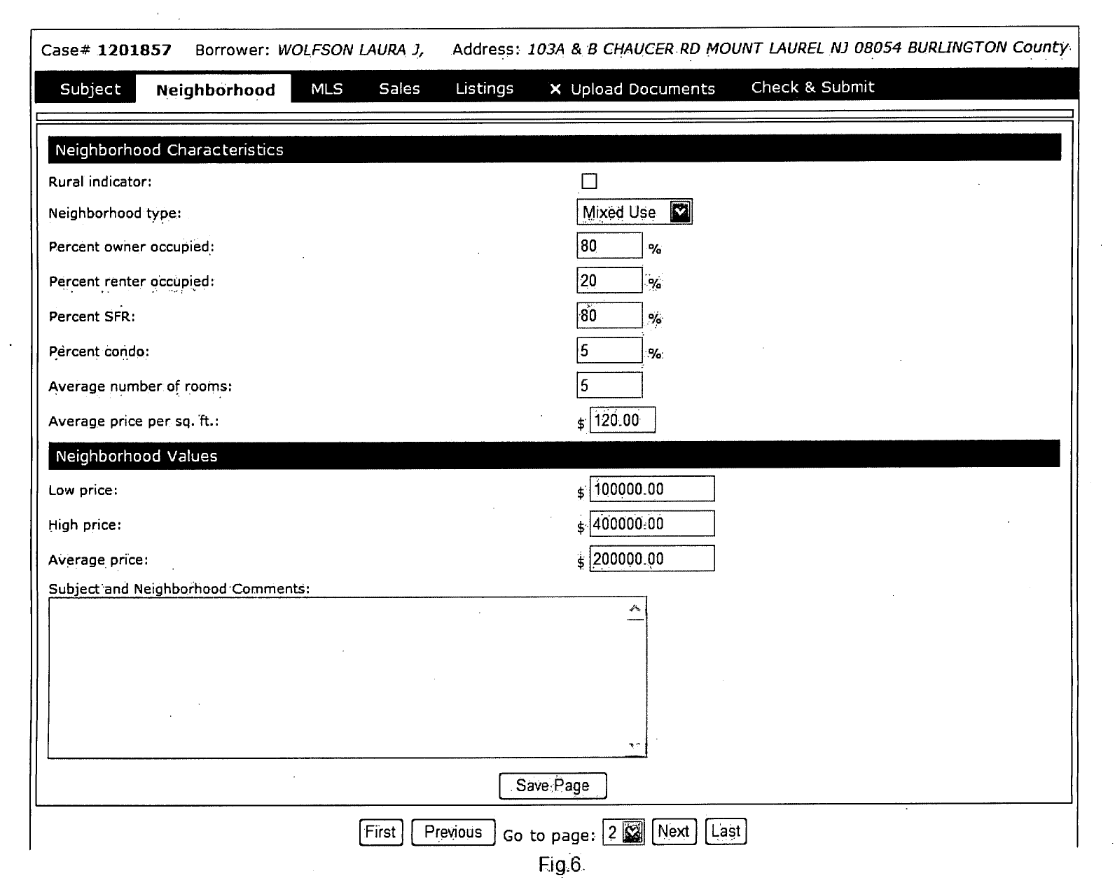

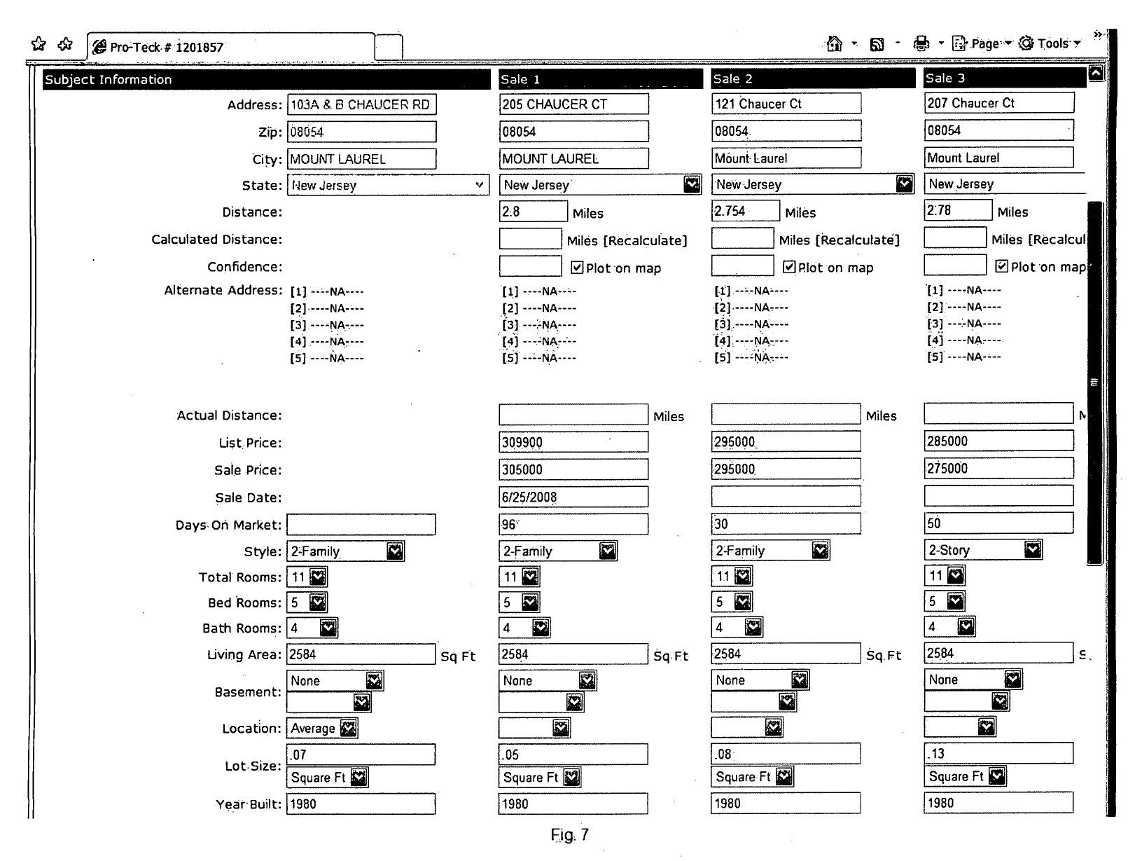

In box 154 it is determined if the report with the next highest level of detail is desired. This would include the collateral points data obtained from integrated data sources, augmented with local data. If this level of detail is desired, the flow passes to box 180 where data is obtained regarding the subject property and comparable properties from a local multiple listing service (MLS). Note that information regarding comparable properties may also be provided through an AVM or other integrated data sources. In box 186, any necessary non-integrated data collection is completed by a local vendor and the flow passes to box 176, where it is determined if the required data was provided by the local real estate professional via on-line data collection forms provided by the system. Exemplars of on-line forms used by the vendors to enter data are shown in FIGS. 5-7. FIG. 5 shows a screen wherein basic information regarding the property may be entered. FIG. 6 shows a screen wherein information regarding the subject property's neighborhood may be entered. FIG. 7 shows a screen wherein information regarding comparable properties to the subject property may be entered.

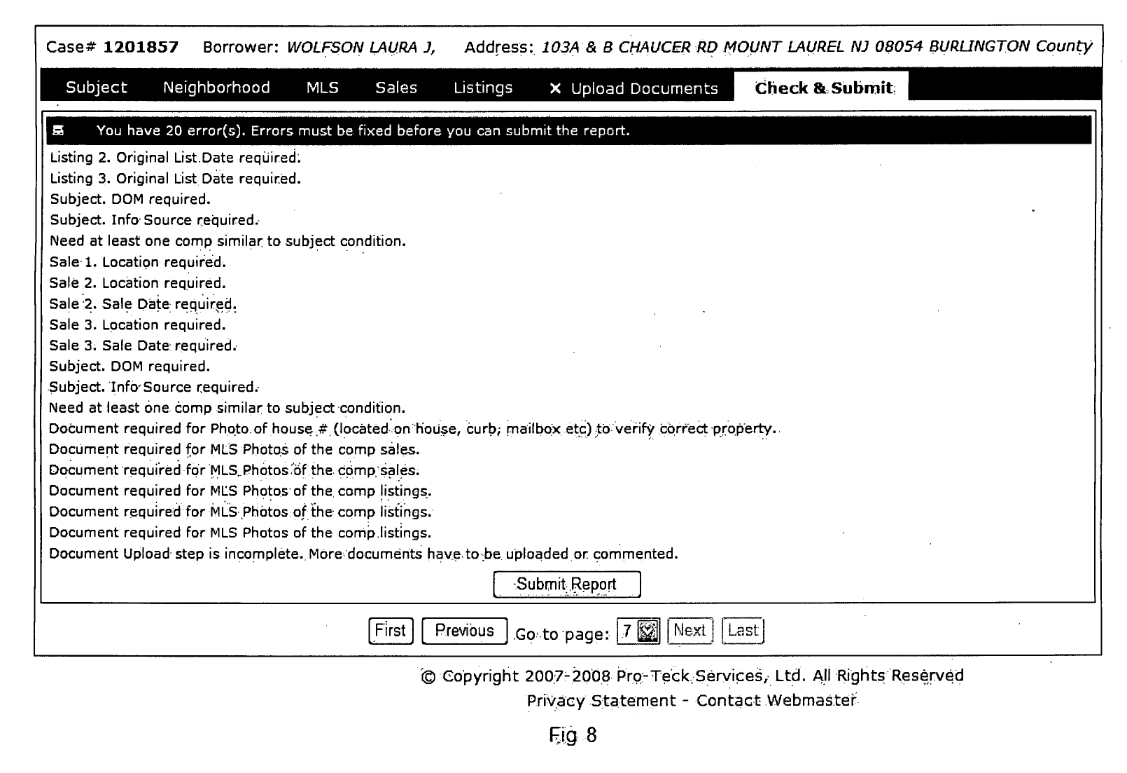

If the forms have been sufficiently completed, flow passes to box 164, where the report is submitted to the review queue and flow continues as previously described. If report forms are not sufficiently complete in box 176, a screen such as the one shown in FIG. 8, showing what information is missing, will be displayed. Flow will then pass back to box 186, where additional information may be added.

In box 156, it is determined if a report with the next higher level of detail is desired. This would include a report including the integrated data sources, augmented by local data on the subject property and comparables from an MLS, as well as the an external site inspection of the property, preferably performed by a real estate professional. If this level of detail is desired, flow passes to box 182 where the local MLS data, subject property data, data regarding the subject property condition and market conditions, and exterior photos are requested. Flow then continues to box 186 where any necessary non-integrated data collection is completed by a local vendor. For data items such as condition of the subject property or market condition, the real estate professional may be asked to enter a rating based on a scale such as Poor-Fair-Average-Good. From this point flow passes to box 186 and continues as previously described. Note that the data regarding the condition of the subject property, as well as the photos of the exterior of the subject property require a site visit.

In box 158 it is determined if a report with the highest level of detail is desired. This would include all of the data and information used in the previous level of detail, augmented by an interior site inspection of the property. If this level of detail is desired then flow continues to box 184 where the local MLS data, subject property data, data regarding the subject property condition and market conditions, and interior and exterior photos of the subject property are requested. The flow then continues to box 186 where any necessary non-integrated data collection is completed by a local vendor. Note that, as with the previous level of detail, the data regarding the condition of the subject property, as well as the photos of the exterior and interior of the subject property require a site visit, preferably by a real estate professional.

Note that the interior and exterior site inspection and the taking of photos are activities that a normal real estate agent would perform in a typical evaluation of a property not using an automated valuation system. However, in this case, the real estate professional is not being asked to make a determination of value, but instead is being asked to provide the data and indicate the quality of the data provided. This data, as well as the rating of the data is used by the system to make the determination of value.

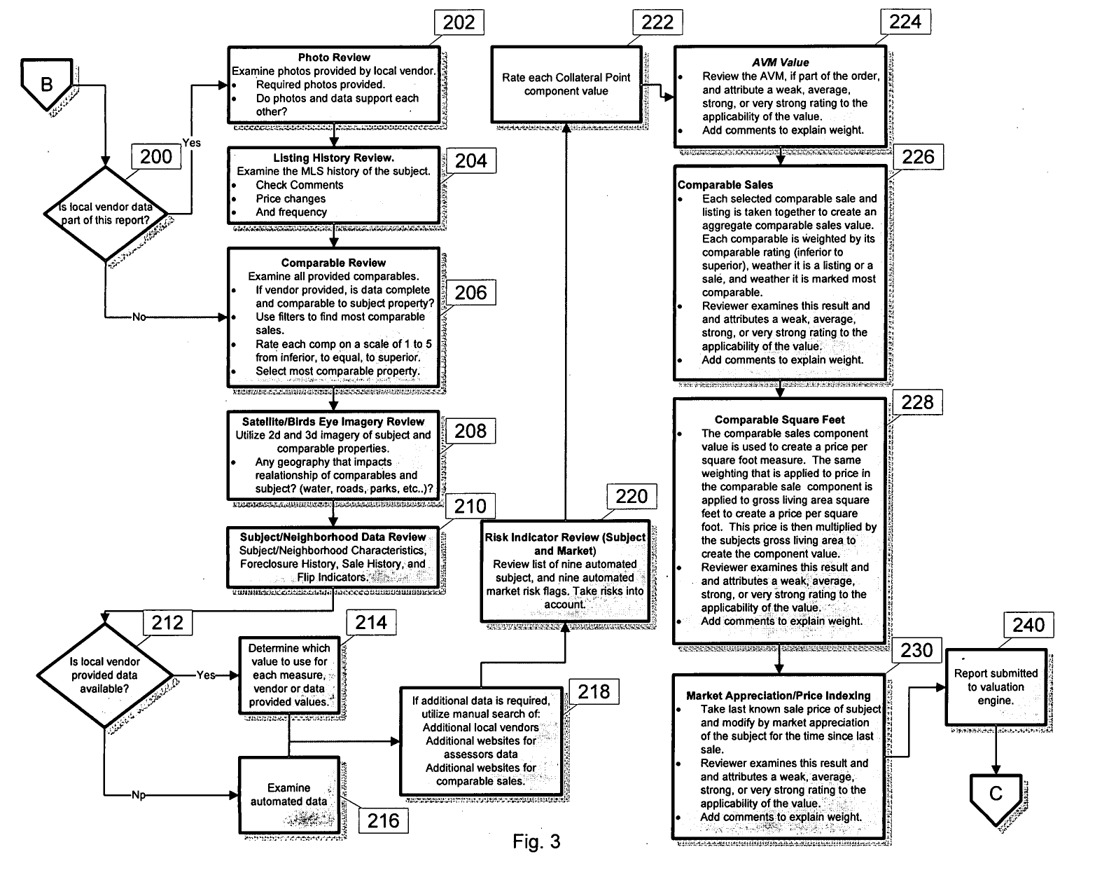

The data review process is shown in FIG. 3. Valuation requests for specific subject properties may be removed from the queue into which they were placed in box 164. For each of those reports the following review process occurs and is performed by a real estate professional.

In box 200 is it determined if local vender data is part of the report. Local vendor data would be part of the report if any of the higher level detailed reports in boxes 156 and 158 were selected in FIG. 2. If so, flow proceeds to box 202 where a review of the photographs are performed. The photographs are checked to make sure that the required photos are provided and that the photos and the data are consistent with each other.

Flow then passes to box 204, where a review of the listings of the particular property is performed. In this review, the reviewer is reviewing the subject property's listing and sale history. While such information is not used directly in the calculation the subject property's listing history will inform the appraiser as to the subject property's historic values and alert them to any potentially fraudulent transactions that can be taken into consideration when rating the quality and applicability of the metrics used, as described below.

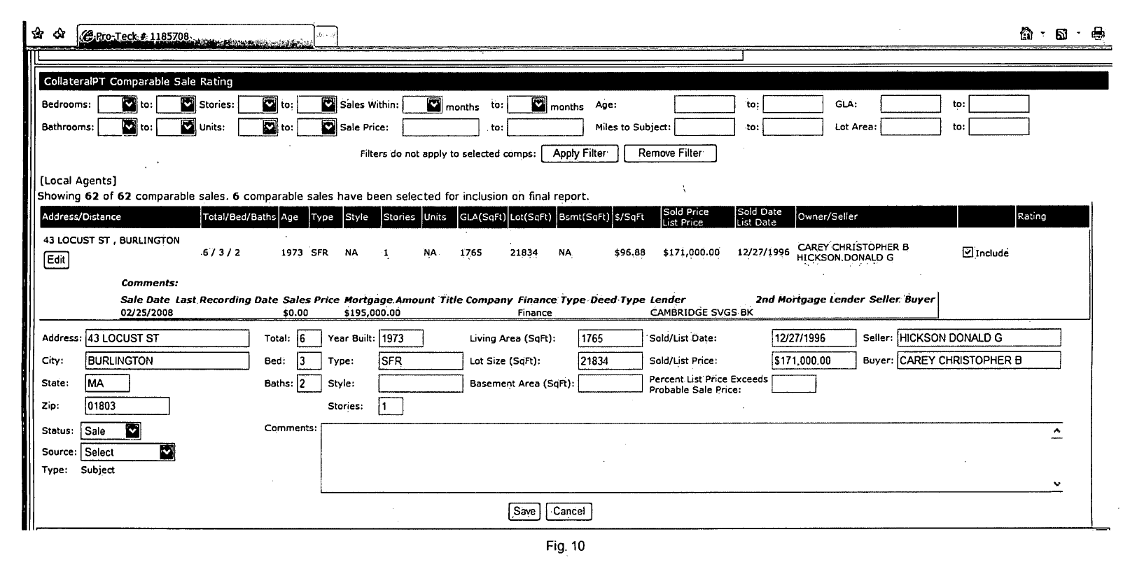

Flow then passes to box 206. Box 206 can also be reached from box 200 if one of the higher level detailed reports is not selected. In box 206, a review of comparable properties is performed by the real estate professional. If a real person, such as a the real estate professional performing the site inspection, has provided a list of comparables, the comparables are checked to make sure that they are good comparables with respect to the subject property. Comparable properties are typically properties having the same style, are similarly sized, are similarly situated with respect to geographical points of interest and are of similar age to the subject property. For all comparable properties, provided by a real person or automatically obtained from an integrated data source, filters may be used to find the most comparable properties. The reviewer then rates each comparable on a scale of 1-5 with 1 being inferior, 3 being equal and 5 being superior. The most comparable property is also identified. FIG. 10 shows an exemplar screen wherein the reviewer may select which comparable properties to include in the report and wherein the reviewer may also enter the rating for each comparable.

Flow then passes to box 208 where satellite and bird's eye imagery is utilized to examine the subject and the comparable properties. Once again, this information is not used directly in the calculation of the valuation of the subject property, but is an intangible which may be used to rate the metrics or set risk indicators. In particular, the reviewer is looking for any geographic characteristics that may impact the relationship of comparables to the subject properties, such as proximity to water, roads, parks, schools, etc. which may make one property more or less desirable then the potential comparable property. For example, if all comparables are one side of a river, but the subject property is on the other side, the validity of the comparables with respect to the subject property may be brought into question. With this information, the real estate professional can return to box 206 and make additional applicable adjustments to the selection and weighting of comparable properties.

Flow then passes to box 210 where a review of the neighborhood of the subject property occurs. The reviewer is looking in particular for history of foreclosures in the neighborhood, history of sales in the neighborhood and indicators of flipping, as well as other flags that may indicate risks, such as a declining neighborhood.

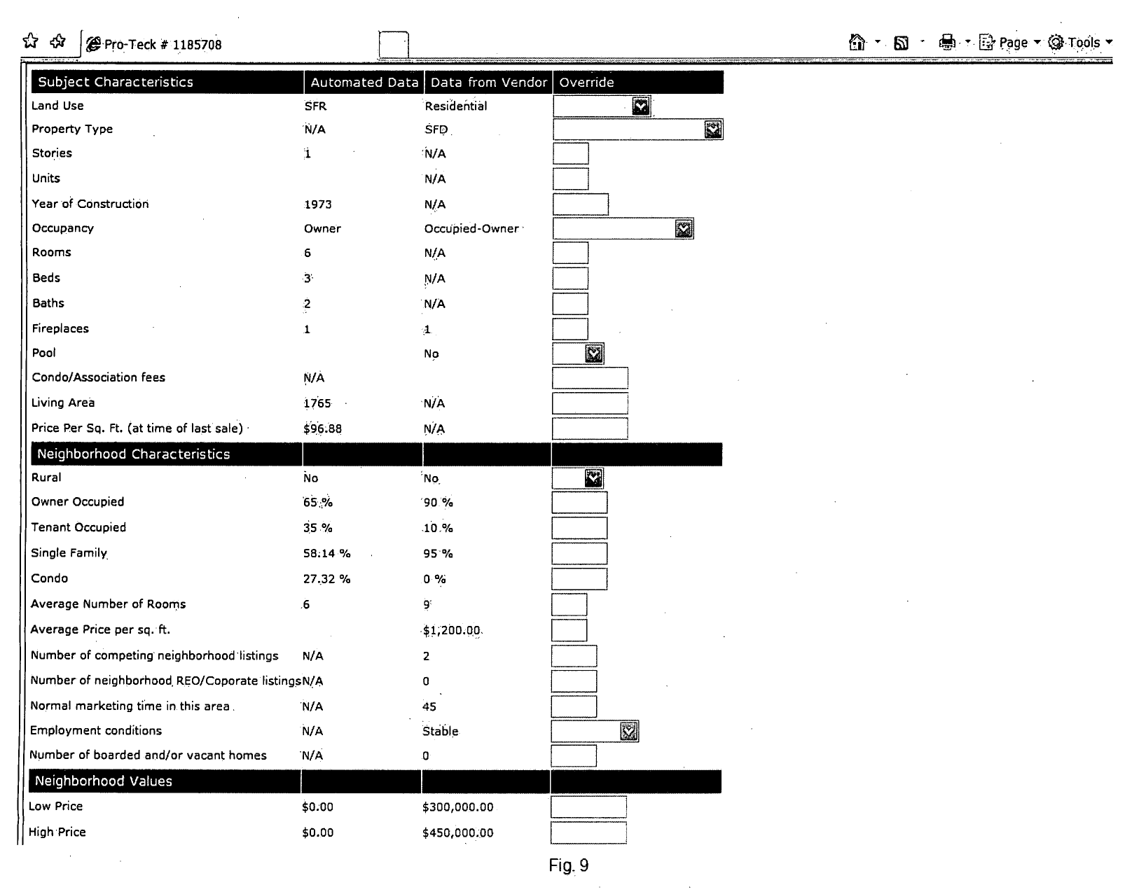

Flow then continues to box 212 where it is determined if local vendor provided data is available or if the valuation is to be based solely on data from integrated data sources. If local vendor data is available, the reviewer determines whether it is better to use the local vendor-provided data or to utilize the data obtained from the integrated data sources. An exemplar screen wherein the reviewer may select to use either the integrated data points or the vendor-provided data points is shown in FIG. 9. The reviewer may also override any data point. If no vendor provided data is available in box 212, flow continues to box 216 where only the data from integrated data sources is examined.

In box 218 it is determined if additional data is required to make the valuation. If additional data is required, a manual search may be performed. This additional searching is typically performed utilizing local vendors or additional web sites where assessment data or comparable sales data may be manually obtained.

Flow then passes to box 220, where a review of risk indicators is performed. The risk indicators are intangibles which include both subject property risk and market risk factors, and consist of a series of flags that may be set, indicating that a certain risk factor is present. These risk factors may include the following, but this is not an exhaustive or exclusive list:

Subject Property Risk Flags:
Non-residential use of land;
Property is not owner occupied;
Submitted value is inflated versus the adjusted prior sale value;
There has been a foreclosure sale of the property in the past 3 years;
There has been a pre-foreclosure sale of the property in the past 3 years;
There have been multiple sales of the property within 90 days;
Submitted price per square foot is inflated versus the average price per square foot of comparables;
Submitted value if inflated versus final valuation of the system;
Submitted price per square foot is inflated versus the average price per square foot of the market;
Property is over or under improved;
Property has fair or poor marketability;
Property is in fair or poor condition.

Market Risk Indicators:
Rural indicator;
Less that a pre-determined percentage (i.e., 70%) of the market is owner occupied;
Higher that a pre-determine percentage (i.e., 30%) of the market is renter occupied;
Indication of flips within the subject ZIP code;
Percentage of foreclosures in the neighborhood;
Current general market condition is depressed/slow;
Employment condition in the neighborhood is declining;
Pre-determined number of boarded or vacant properties in the neighborhood;
High percentage REO in the neighborhood.

Flow then passes to box 222, where the reviewer is asked to rate the value of various metrics upon which the valuation is to be based. The ratings, in the preferred embodiment, use a scale of weak, average, strong or very strong, with the rating indicating the applicability of the particular metric as an indicator of value of the subject property. The intangible data points mentioned above may be taken into consideration by the reviewer when rating the metrics. The ratings will be used to weight the metric in a calculation for the final valuation of the subject property. In the preferred embodiment of the invention, there are four metrics that are used and submitted to the valuation engine, although it should be understood that other metrics, including the risk indicators, could easily be integrated into the calculation:
1) a value from an automated valuation model;
2) an value representing the weighted average of comparable sales;
3) a value representing the weighted average price per square foot of comparables; and
4) market appreciation and price indexing.

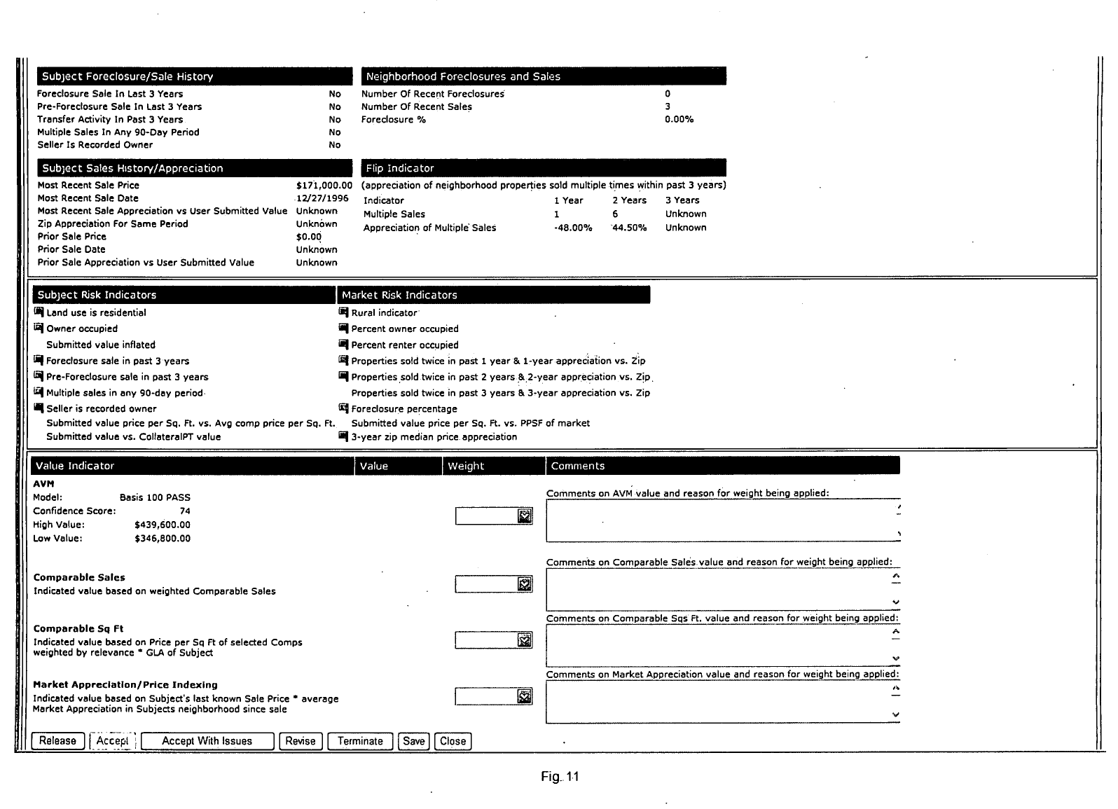

FIG. 11 shows an exemplar screen wherein the reviewer may enter the weightings for each of the metrics to be used in the calculation of the final valuation.

In box 224, the AVM value is rated. The reviewer reviews the value provided by the AVM, if it is part of the data set, and may rate the AVM value as on the applicability scale mentioned above. Comments may be added to explain the weights given to the AVM value. The reviewer's rating of the AVM value may be based, in part, on which model has produced the value, a confidence score, if provided by the model and the supporting data in the AVM report.

The flow then passes to box 226, where an aggregate comparable sales price metric is calculated. Each of the available comparables is first weighted by its comparable rating provided by the reviewer in box 206. Also taken into account is whether the comparable is a listing or a completed sale. If a comparable is a listing, as opposed to a completed sale, the value of the comparable will first be normalized by a factor that takes into account the average difference between listing prices and the final sales prices for the market. In addition, the comparable that has been identified as the best comparable may be given a higher weight than the remainder of the comparables, such as 1.5 as opposed to 1.0 for all other comparables.

The comparables are then aggregated to create an aggregate, weighted comparable sales value. The reviewer examines the result and then rates the aggregate comparable sales value on the applicability scale discussed above. Again, comments may be provided to explain the weighting given to the aggregate comparable value.

In box 228, comparable properties are used to create a price per square foot metric. For each of the comparables, a price per square foot is obtained and the rating applied to the comparable in box 206 is used to weight the particular comparable. A weighted, average aggregate price per square footage for the comparables is thus is obtained. The price per square foot of the subject property is then calculated by interpolating the aggregate price per square footage of the comparables with the square footage of the subject property. The reviewer then examines this result and provides a rating on the applicability scale discussed above. Comments may be again be added to explain the weighting given to the value.

Flow then passes to box 230 where any potential market appreciation or depreciation is taken into account. The last known sale price of the subject property is utilized and the market appreciation/depreciation since the time of the last sale is applied to obtain an adjusted appreciated/depreciated value for the property. The reviewer also rates this metric on the applicability scale discussed above. Once again, comments may be used to explain the rating provided.

Note that for any metric for which data is unavailable (for example, if no AVM model produces a hit or if no last sale price is available), that metric may be discarded and will not become part of the calculation of the final valuation.

Once the reviewer is done rating the metrics, the metrics are submitted to the valuation engine in box 240.

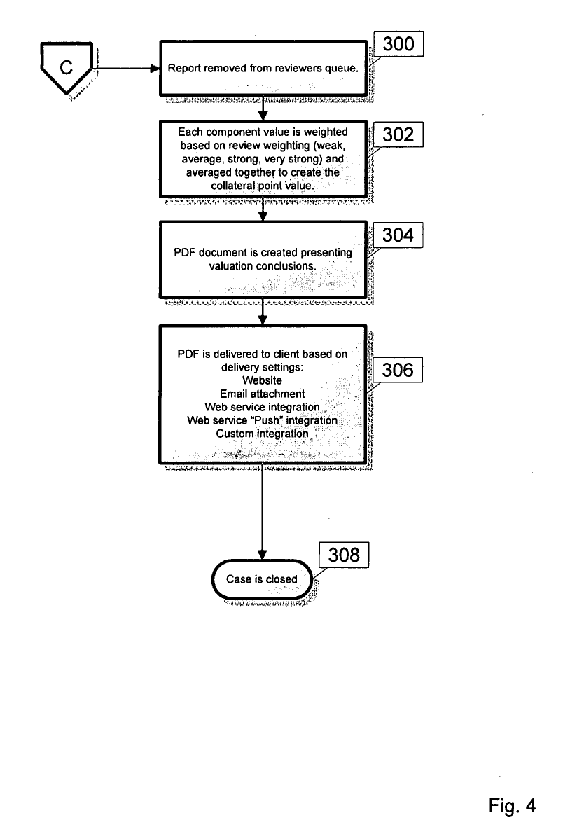

The flow then passes to FIG. 4. The report is removed from the reviewer's queue in box 300 and the valuation calculation is performed in box 302. For the valuation calculation, each metric value is weighted based on the reviewer's rating of the applicability of that metric and the weighted values are averaged together to create the final valuation. In the preferred embodiment, the following equation is used, but other methods of weighted averaging may also be used, and the metrics used also may differ in other embodiments of the invention:

$$\frac{( {AVM}_{v} * {AVM}_{w} ) + ( {CS}_{v} * {CS}_{w} ) + ( {CSF}_{v} * {CSF}_{w} ) + ( {MA}_{v} * {MA}_{w} )}{{AVM}_{w} + {CS}_{w} + {CSF}_{w} + {MA}_{w}}$$

where the subscript “v” indicates the value for each of the metrics and the subscript “w” indicates the weighting for each of the metrics.

The various applicability ratings may be assigned different weightings. For example, in the preferred embodiment of the invention, the weightings are assigned as follows:

| Metric Rating | Weight |
|---|---|
| Weak | 0 |
| Average | 1 |
| Strong | 2 |
| Very Strong | 4 |

In box 304 a report is created presenting the conclusions of the valuation and in box 306 the report is delivered to the client in one of a variety of different ways including via download from a website, email or any other commonly known methods of electronically or physically delivering a document to a person. In box 308 the case is closed and control would return to the point where the review of the next valuation request in the queue occurs.

It is understood that the embodiment described is exemplary only and that the scope of the invention is limited only by the claims below.

We claim:

1. A method for calculating a valuation for a subject property comprising:
a. gathering data from one or more sources regarding one or more metrics used to calculate a value for said subject property;
b. for each metric for which data has been gathered, rating said data as to it's quality and applicability to the value of said subject property;
c. weighting the data for each of said metrics based on said ratings; and
d. calculating a value for said subject property based on said weighted metrics.

2. The method of claim 1 wherein said metrics are selected from a group comprising a value for the subject property supplied by an automated value model, an aggregate value of comparable properties, an aggregate price per square foot of comparable properties and a value for the subject property based on market appreciation over time.

3. The method of claim 1 wherein said gathered data includes at least one value generated by an automated valuation model.

4. The method of claim 3 wherein said data further includes data regarding comparable properties.

5. The method of claim 3 wherein said data regarding comparable properties may be gathered from an automated valuation model or may be provided manually.

6. The method of claim 5 wherein said gathered data further includes data from a local multiple listing service regarding comparable properties and said subject property.

7. The method of claim 6 wherein said gathered data further includes data regarding the condition of said subject property.

8. The method of claim 7 wherein said data further includes data regarding current market conditions.

9. The method of claim 8 wherein said data regarding said market conditions includes general market information and market information specific to said subject property.

10. The method of claim 1 further comprising the step of analyzing a set of risk factors and determining if said risk factors exist based on said gathered data.

11. The method of claim 10 wherein said risk factors are selected from a group comprising risk factors specific to said subject property and risk factors indicating market risk.

12. The method of claim 1 further comprising the step of generating a report containing said calculated value of said subject property and supporting data.

13. A system for calculating the value of real property comprising:
a. a computer having software installed thereon, said software comprising:
b. a data gathering module, for gathering data from one or more sources regarding one or more metrics used to calculate the value of said real property;
c. a rating module, for rating, for each metric, data gathered for that metric as to its quality and applicability to the value of said real property;
d. a weighting module, for weighting each of said metrics, based on said ratings; and
e. a valuation module, for calculating a value for said real property based on said weighted metrics.

14. The system of claim 13 wherein said one or more data sources includes an automated valuation model.

15. The system of claim 14 wherein said data includes information regarding comparable properties.

16. The system of claim 15 wherein said data includes data from a local multiple listing service regarding comparable properties and said subject property.

17. The method of claim 13 wherein said metrics are selected from a group comprising a value for the subject property supplied by an automated value model, an aggregate value of comparable properties, an aggregate price per square foot of comparable properties and a value for the subject property based on market appreciation over time.

18. The method of claim 13 further comprising the step of analyzing a set of risk factors and determining if said risk factors exist based on said gathered data.

19. The method of claim 18 wherein said risk factors are selected from a group comprising risk factors specific to said subject property and risk factors indicating market risk.

20. The method of claim 13 further comprising a report generation module for producing a report containing a valuation of said subject party.

21. The method of claim 20 wherein said report further includes data supporting said valuation.

22. The method of claim 21 wherein said report further includes data regarding risk factors specific to said subject property and risk factors indicating market risk.
